(19) United States
(12) Patent Application Publication
(10) Pub. No.: US 2020/0226085 A1
(43) Pub. Date: Jul. 16, 2020

(54) DATA PROCESSING SYSTEM

(71) Applicant: HUAWEI TECHNOLOGIES CO., LTD., Shenzhen (CN)

(72) Inventors: Jihui WANG, Beijing (CN); Yu LIU, Shanghai (CN); Zhengming GU, Shenzhen (CN); Binghui WANG, Shanghai (CN); Jin QIAN, Shenzhen (CN); Xiancheng TAN, Shanghai (CN); Bo REN, Xi'an (CN)

(21) Appl. No.: 16/828,357

(22) Filed: Mar. 24, 2020

Related U.S. Application Data
(63) Continuation of application No. PCT/CN2017/106390, filed on Oct. 16, 2017.

(51) Int. Cl. G06F 13/38; G06F 13/40

(52) U.S. Cl. CPC G06F 13/382; G06F 13/4072; G06F 2213/0042; G06F 2213/3812; G06F 13/4022

(57) ABSTRACT

This application provides a data processing system, and the data processing system includes: a Universal Serial Bus (USB) device; a general-purpose processor, deployed with a USB driver; and a dedicated processor, deployed with a first driver, where the first driver is configured to drive a data exchange between the USB device and the dedicated processor, to effectively reduce a transmission delay.

### CROSS-REFERENCE TO RELATED APPLICATIONS

This application is a continuation of International Application No. PCT/CN2017/106390, filed on Oct. 16, 2017, the disclosure of which is hereby incorporated by reference in its entirety.

### TECHNICAL FIELD

This application relates to the field of electronic technologies, and more specifically, to a data processing system and a data processing method.

### BACKGROUND

A Type-C interface is a new type of Universal Serial Bus (USB) interface, and supports forward and reverse insertion. With increasingly mature Type-C interface technologies, Type-C interfaces are gradually applied to terminal devices such as mobile phones.

An Android system is used as an example. When an external device exchanges data with a terminal device such as a mobile phone by using a Type-C interface, only a general-purpose processor can directly exchange data with a USB device in the terminal device. In other words, direct data access can be performed only between a general-purpose processor and a USB device. In this way, data received from the USB device can be transmitted to a dedicated processor (for example, a digital signal processing (DSP) processor) only after passing through each processing module in the general-purpose processor. For some application scenarios in which delay requirements are relatively high (for example, an application scenario in which a Type-C headset is used for a voice conversation), a relatively large transmission delay is generated in this data transmission manner, and user experience is affected.

Therefore, a technology needs to be provided, to help reduce a data transmission delay and improve user experience.

### SUMMARY

This application provides a data processing system, to effectively reduce a data transmission delay, and improve user experience.

According to a first aspect, a data processing system is provided, and the data processing system includes:

a Universal Serial Bus USB device;

a general-purpose processor, deployed with a USB driver; and

a dedicated processor, deployed with a first driver, where the first driver is configured to drive a data exchange between the USB device and the dedicated processor.

Therefore, according to the data processing system provided in this embodiment of this application, the dedicated processor is deployed with the first driver configured to drive the data exchange between the dedicated processor and the USB device, so that the USB device can exchange data with the dedicated processor. When data can be processed by the dedicated processor, the first driver in the dedicated processor may be directly used to drive the USB device, to implement the data exchange between the USB device and the dedicated processor. The general-purpose processor no longer needs to forward the data to the dedicated processor. Instead, the data can be directly transmitted between the USB device and the dedicated processor. A transmission delay is reduced, and user experience is improved. In addition, because the general-purpose processor no longer forwards the data to the dedicated processor, the general-purpose processor can enter a sleep state, and power consumption is also reduced.

Optionally, the USB device includes a USB interface configured to connect to an external device, and the general-purpose processor is configured to:

when the external device is inserted into the USB interface, obtain a device type of the external device; and

if the device type of the external device is an audio device, instruct the dedicated processor to exchange data with the USB device.

Optionally, the USB device includes a first USB host controller, a second USB host controller, and a switching control module, the first USB host controller is connected to the dedicated processor, the second USB host controller is connected to the general-purpose processor, the switching control module controls either one of the first USB host controller and the second USB host controller, and transmission power consumption of the first USB host controller is lower than transmission power consumption of the second USB host controller.

Therefore, according to the data processing system provided in this embodiment of this application, two USB host controllers with different transmission power are disposed in the USB device. A USB host controller (for example, the first USB host controller) with lower transmission power is connected to the dedicated processor, and a USB host controller (for example, the second USB host controller) with higher transmission power is connected to the general-purpose processor. When data can be processed by the dedicated processor, the data exchange between the USB device and the dedicated processor is implemented by using the USB host controller with lower transmission power, to help further reduce power consumption.

Optionally, the USB device includes a USB interface configured to connect to an external device; and

after the external device is removed from the USB interface, the switching control module controls the first USB host controller, or the switching control module controls the second USB host controller.

Therefore, according to the data processing system provided in this embodiment of this application, in a default state (that is, after the external device is removed from the USB interface or before the external device is inserted into the USB interface), the data processing system may set a relationship between the switching control module and a USB host controller to reduce power consumption of the data processing system in different scenarios. If the switching control module controls a USB host controller (for example, the first USB host controller) connected to the dedicated processor, when data can be processed by the dedicated processor, the USB device can directly exchange data with the dedicated processor without performing a series of switching operations, so that power consumption is reduced. If the switching control module controls a USB host controller (for example, the second USB host controller) connected to the general-purpose processor, when data can be processed by the general-purpose processor, the USB device can directly exchange data with the general-purpose processor without performing a series of switching operations, so that power consumption is reduced.

Optionally, the dedicated processor is a digital signal processing DSP processor.

Optionally, the USB device includes a USB interface configured to connect to an external device, and the USB interface is a Type-C interface.

According to a second aspect, a data processing method is provided, and is applied to a data processing system including a Universal Serial Bus USB device, a general-purpose processor, and a dedicated processor, where the USB device includes a USB interface configured to connect to an external device, the general-purpose processor is deployed with a USB driver, the dedicated processor is deployed with a first driver, and the first driver is configured to drive a data exchange between the USB device and the dedicated processor; and the method includes:

when the external device is inserted into the USB interface, obtaining, by the general-purpose processor, a device type of the external device; and

if the device type of the external device is an audio device, instructing, by the general-purpose processor, the dedicated processor to exchange data with the USB device.

According to a third aspect, a computer readable storage medium is provided, where the computer readable storage medium stores a program, and the program enables a communications device to perform any method according to the second aspect and the possible implementations of the second aspect.

According to a fourth aspect, a computer program is provided, and when being executed on a computer, the computer program enables the computer to implement any method according to the second aspect and the possible implementations of the second aspect.

### BRIEF DESCRIPTION OF DRAWINGS

FIG. 1 is a schematic structural diagram of a USB device according to an embodiment of this application;

FIG. 2 is a schematic structural diagram of a data processing system according to an embodiment of this application;

FIG. 3 is a schematic structural diagram of a data processing system in the prior art;

FIG. 4 is a schematic structural diagram of a data processing system according to another embodiment of this application; and

FIG. 5 is a schematic flowchart of a data processing method according to an embodiment of this application.

### DESCRIPTION OF EMBODIMENTS

The following describes the technical solutions in this application with reference to the accompanying drawings.

The technical solutions in the embodiments of this application may be applied to an Android system, or may be applied to another system applicable to a terminal device, for example, an iOS system.

In the embodiments of this application, the terminal device is a terminal device including a USB device. The terminal device may be a mobile phone, a laptop computer, a tablet computer, a portable music player, or the like. It may be understood that, although the embodiments of this application are described by using the terminal device as an example, another device may actually include a USB device, a dedicated processor, and a general-purpose processor in the embodiments, or may be configured to implement a related method, thereby having a similar function or achieving an approximate technical effect.

In the embodiments of this application, a device that can exchange data with the terminal device by using the USB device is referred to as an external device. The external device may be an audio device (for example, a headset, a sound box, or a portable music player), or a video device (for example, a video conferencing device, a camera, a display, or a digital camera), or another type of device, for example, a digital camera, a USB flash disk, a removable hard disk, a keyboard, or a mouse.

In the embodiments of this application, the general-purpose processor may be configured to: interpret a computer instruction and process data in computer software. The terminal device completes each piece of work under command and intervention of a control instruction of the general-purpose processor, and the general-purpose processor may perform a plurality of tasks or any task in theory. The general-purpose processor may be a microprocessor or any conventional processor, and is a core component of the terminal device.

For example, the general-purpose processor may be a central processing unit (CPU), a microcontroller unit (MCU), or the like.

In the embodiments of this application, because processing logic of the dedicated processor is embedded or partially embedded into a chip, the dedicated processor can perform only a single-function and specific task (for example, an audio service or a video service). In other words, the dedicated processor has a better processing capability when computing a specific task, but cannot compute another task. The dedicated processor may be an application-specific integrated circuit (ASIC), a network processor (NP), a field-programmable gate array (FPGA) or another programmable logic device, a discrete gate or a transistor logic device, a discrete hardware component, or the like.

For example, the dedicated processor may be a DSP processor, and the DSP processor may execute an audio service, a video service, an audio and video service, and the like. For another example, the dedicated processor may alternatively be an image signal processing (ISP) processor. For another example, the dedicated processor may alternatively be a graphics processing unit (GPU).

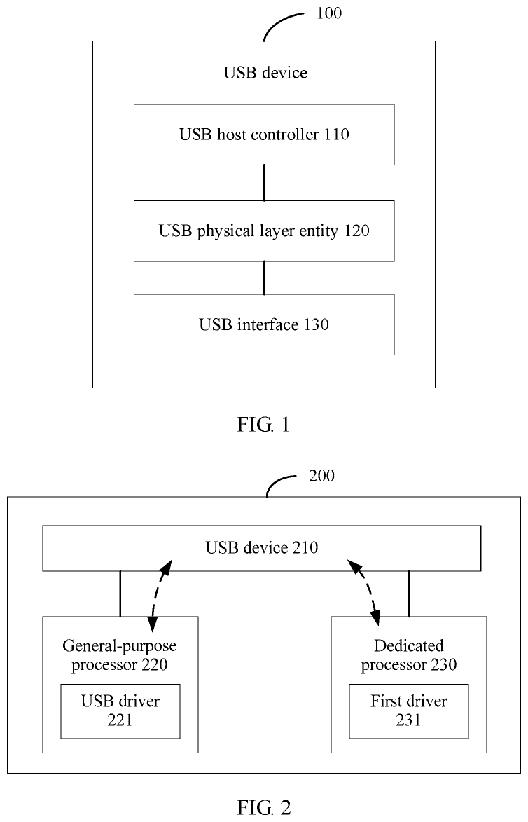

FIG. 1 is a schematic structural diagram of a USB device 100 according to an embodiment of this application. As shown in FIG. 1, the USB device 100 is configured to establish a physical link for a data exchange between an external device and a terminal device. The USB device 100 includes a USB host controller 110, a USB physical layer entity (USB PHY) 120, and a USB interface 130.

The USB host controller 110 is connected to a processor inside the terminal device, to implement a data exchange between the USB device and the processor. Specifically, the USB host controller is configured to execute a control operation performed by the terminal device on a USB bus and the external device, and the control operation includes a reset control operation, enumeration control, an operation of controlling or driving data sending and receiving, or the like. The USB physical layer entity 120 is a chip configured to interface with an external signal. The USB physical layer entity is configured to: identify a physical signal on the USB interface, such as an electrical signal, forward the physical signal to the USB host controller, convert an operation of the USB host controller into a physical signal, and send the physical signal to the external device by using the USB interface. The USB interface 130 is a physical interface, and is configured to connect to the external device, to implement the data exchange between the USB device and the processor.

A related USB host controller and the USB physical layer entity can implement a function of the USB Data Transfer Protocol, and jointly support implementation of the USB device. Specifically, the USB device may be implemented by using software, hardware, or a combination of software and hardware, to realize a USB data transmission capability. For more specific technical details about a USB physical layer and a USB controller, refer to the prior art.

It should be understood that the schematic block diagram of the USB device 100 shown in FIG. 1 shows only a partial structure. The USB device 100 may further include a structure not shown in FIG. 1. For a specific structure, refer to the prior art or a related description below about a USB device in a data processing system in an embodiment of this application.

FIG. 2 is a schematic structural diagram of a data processing system 200 according to an embodiment of this application. As shown in FIG. 2, the data processing system 200 includes a USB device 210, a general-purpose processor 220, and a dedicated processor 230. The foregoing three devices are separately described below.

USB device 210:

The USB device 210 is the same as or similar to a function module of the USB device 100 shown in FIG. 1. For brevity, details are not described herein.

General-purpose processor 220:

In this embodiment of this application, a USB driver 221 is configured in the general-purpose processor 220. When exchanging data with the USB device 210, the general-purpose processor 220 loads the USB driver 221 to drive the USB device 210, to implement a data exchange between the general-purpose processor 220 and the USB device 210.

The USB driver 221 may not only be configured to drive data transmission between the USB device 210 and the general-purpose processor 220, but also be configured to enumerate a device attribute of an external device connected to the USB device 210. For a specific function effect, refer to the prior art, and details are not described herein.

It should be understood that a function entity other than the USB driver may be further configured in the general-purpose processor, and the function entity may run in the general-purpose processor, for example, a user mode space module (namely, an Android module), an audio driver module, a function entity having an audio processing function, a video driver module, or a function entity having a video processing function.

Dedicated processor 230:

In this embodiment of this application, a first driver 231 is configured in the dedicated processor 230, and the first driver 231 is configured to drive a data exchange between the USB device 210 and the dedicated processor 230.

Specifically, device information of the USB device 210 is configured in the first driver 231. To enable the dedicated processor 220 to exchange data with the USB device 210, before the dedicated processor 220 transmits data with the USB device 210, the dedicated processor 220 loads the first driver 231, so that the first driver 231 can drive the USB device 210, to implement the data exchange between the dedicated processor 220 and the USB device 210.

A basic function of the first driver 231 is to drive data transmission between the USB device 210 and the dedicated processor 230, or the first driver 231 may be understood as a simplified version of the USB driver 221.

In addition, the first driver 231 can implement another function in addition to the foregoing function, namely, data transmission. This is not limited in this embodiment of this application.

For example, the first driver 231 may also configure some control commands (denoted as first control commands for ease of understanding and differentiation). The first control command is used to enumerate the device attribute of the external device connected to the USB device, the device attribute of the external device may include a device type of the external device, a data format supported by the external device, or the like, and the data format is an orchestration format, data precision, or the like of data stored in a file or a record. For another example, the first driver 231 may further configure other control commands (denoted as second control commands for ease of understanding and differentiation). The second control command is used to determine a data transmission manner, and the transmission manner includes a transmission manner such as a synchronous transmission manner, an asynchronous transmission manner, or a block transmission manner.

It should be noted that the first control command may be a command including a plurality of instructions, and is used to enumerate the device attribute of the external device connected to the USB device. The second control command may also be a command including a plurality of instructions, and is used to determine the data transmission manner.

It should be understood that a function entity other than the first driver may also be configured in the dedicated processor, for example, a DSP pulse code modulation (PCM) module, an audio and/or video coding/decoding module, or a voice coding/decoding module.

It should be further understood that the data processing system shown in FIG. 2 shows only the USB device, the general-purpose processor, and the dedicated processor. The data processing system further includes another device not shown in FIG. 2, for example, a baseband processor, a power supply, an antenna system, or an input/output device.

Based on the foregoing description and as shown in dashed lines with arrows in FIG. 2, it can be learned that, in the data processing system, the USB device 210 can exchange data with the general-purpose processor 220, and the USB device 210 can also exchange data with the dedicated processor 230. In other words, the USB device 210 can exchange data with processors of different types or with different function effects.

As an example instead of a limitation, in this embodiment of this application, the data processing system may include one dedicated processor, or include a plurality of dedicated processors. The plurality of dedicated processors are separately configured to perform different tasks. A first driver is configured in each dedicated processor, and is configured to drive a data exchange between each dedicated processor and the USB device.

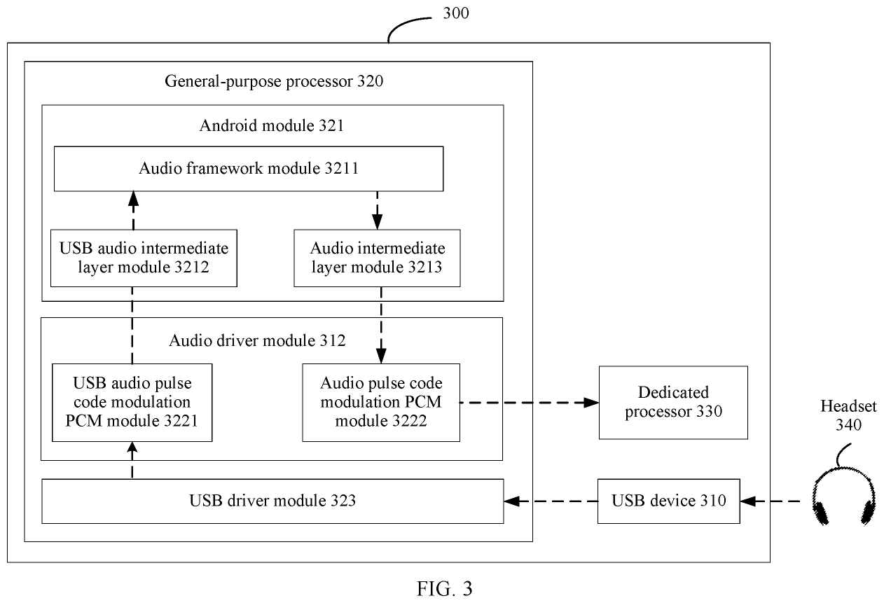

In the prior art, as shown in FIG. 3, in addition to a USB driver module 323, the general-purpose processor 320 further includes an Android module 321 and an audio driver module 322. The Android module 321 may be logically understood as user mode space, and is configured to process an Android system task. The Android module 321 includes an audio framework (namely, Audio Flinger) module 3211, a USB audio intermediate layer (namely, Audio Hal) module 3212, and an audio intermediate layer module 3213. The audio driver module 322 is configured to drive an audio sound card or activate a function of an audio sound card, and includes a USB audio PCM module 3221 and an audio PCM module 3222.

An uplink audio data transmission process, to be specific, a process in which an external device (for example, a headset) sends data to a terminal device is used as an example. A data transmission process in the prior art is briefly described based on FIG. 3. In the uplink audio data transmission process, the headset 340 first transmits audio data to the general-purpose processor 320 by using a USB device 310, and then transmits the audio data to the dedicated processor 330. A specific transmission path is as follows: USB device 310→USB driver module 323→USB audio PCM module 3221→USB audio intermediate layer module 3212→audio framework module 3211→audio intermediate layer module 3213→audio PCM module 3222→dedicated processor 330.

A downlink audio data transmission process is similar to the uplink voice data transmission process, and only a transmission direction changes. For brevity, details are not described herein.

In the prior art, the audio data can be transmitted to the dedicated processor only after passing through the general-purpose processor. In this transmission process, because a plurality of modules (only some modules are shown in FIG. 1) are configured in the general-purpose processor, the audio data is transmitted between any two modules. The audio data can be transmitted to a next module only after some of the audio data is cached in each module. Consequently, a relatively large transmission delay is generated. In this case, user experience is affected due to the relatively large transmission delay in a scenario in which a delay requirement is relatively high, for example, a real-time voice scenario or video call scenario.

According to the data processing system provided in this embodiment of this application, the dedicated processor is deployed with the first driver configured to drive the data exchange between the dedicated processor and the USB device, so that the USB device can exchange data with the dedicated processor. When data can be processed by the dedicated processor, the first driver in the dedicated processor may be directly used to drive the USB device, to implement the data exchange between the USB device and the dedicated processor. The general-purpose processor no longer needs to forward the data to the dedicated processor. Instead, the data can be directly transmitted between the USB device and the dedicated processor. A transmission delay is reduced, and user experience is improved. In addition, because the general-purpose processor no longer forwards the data to the dedicated processor, the general-purpose processor can enter a sleep state, and power consumption is also reduced.

It should be noted that, that the two devices (for example, the dedicated processor and the USB device) described in this specification directly exchange data indicates that data is transmitted between the two devices without being forwarded by a third device. A similar description below about a direct data exchange performed between the two devices is the same as described herein. To avoid repeated description, details are not described below.

Optionally, the USB device 210 includes a first USB host controller 211, a second USB host controller 212, and a switching control module 213. The first USB host controller 211 is connected to the dedicated processor 230, the second USB host controller 212 is connected to the general-purpose processor 220, the switching control module 213 controls either one of the first USB host controller 211 and the second USB host controller 212, and transmission power consumption of the first USB host controller 211 is lower than transmission power consumption of the second USB host controller 212.

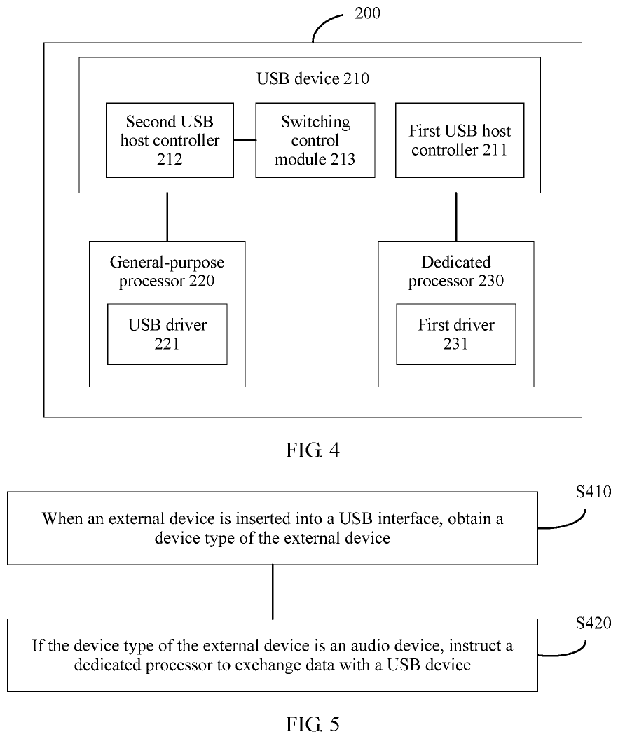

Specifically, as shown in FIG. 4, the USB device 210 may include two USB host controllers. The first USB host controller 211 is corresponding to the dedicated processor 230, that is, the first USB host controller 211 is connected to the dedicated processor 230, and the second USB host controller 212 is corresponding to the general-purpose processor 220, that is, the second USB host controller 212 is connected to the general-purpose processor 220.

To implement a switching process between the two USB host controllers, the USB device 210 further includes the switching control module 213. The switching control module 213 establishes a communications connection to a USB interface by using a USB physical layer entity, and the switching control module 213 controls either one of the first USB host controller 211 and the second USB host controller 212 based on the communications connection.

Specifically, in an initial state or a default state (namely, a state in which an external device is disconnected from the USB device 210) of the data processing system, if the switching control module 213 controls the second USB host controller 212 and data can be transmitted with the dedicated processor 230 by using the USB device 210, after the external device is inserted into the USB interface, the switching control module 213 switches from a state in which the switching control module 213 controls the second USB host controller 212 to a state in which the switching control module 213 controls the first USB host controller 211. In this way, the switching control module 213 can be used to implement switching of a data transmission path. Alternatively, in an initial state or a default state of the data processing system, if the switching control module 213 controls the first USB host controller 211 and data can be transmitted with the general-purpose processor 220 by using the USB device 210, the switching control module 213 switches from a state in which the switching control module 213 controls the first USB host controller 211 to a state in which the switching control module 213 controls the second USB host controller 212. In this way, the switching control module 213 can be used to implement switching of a data transmission path.

It should be understood that the switching control module 213 controls a USB host controller in a plurality of implementations. This is not limited in the embodiments of this application. All manners in which the switching control module 213 is used to control the USB host controller fall within the protection scope of the embodiments of this application. For example, the switching control module 213 may control the USB host controller in a physical connection manner.

In addition, generally, because a processing capability of the dedicated processor 230 is lower than that of the general-purpose processor 220, transmission power of the first USB host controller 211 corresponding to the dedicated processor 230 is lower than that of the second USB host controller 212 corresponding to the general-purpose processor 220.

In specific implementation, USB host controllers corresponding to the two processors may be selected by using a plurality of factors that determine transmission power of the USB host controllers. For example, generally, a USB host controller with a higher version number has a stronger processing capability but consumes larger transmission power. Therefore, a suitable USB host controller may be selected based on a version number of the USB host controller. To be specific, a version of the first USB host controller 211 may be lower than a version of the second USB host controller 212, and the first USB host controller may be USB Host 2.0, and the second USB host controller may be USB Host 3.0. For another example, a host controller with a higher transmission rate has a stronger processing capability but consumes larger transmission power. Therefore, a suitable USB host controller may be selected based on a transmission rate of the USB host controller.

It should be understood that the foregoing examples for the two USB host controllers are merely used for illustration purposes. All implementations in which the transmission power of the first USB host controller 211 can be made lower than that of the second USB host controller 212 fall within the protection scope of the embodiments of this application.

As an example instead of a limitation, the USB device may alternatively include only one USB host controller, and the USB host controller is separately connected to the two processors.

It should be noted that when the data processing system includes N (N is an integer greater than 1) dedicated processors, the USB device may include at least one USB host controller. In addition, when the USB device includes M (M is an integer greater than or equal to 1) USB host controllers, the N dedicated processors are corresponding to the M USB host controllers, and each USB host controller may be connected to at least one dedicated processor.

Therefore, according to the data processing system provided in this embodiment of this application, two USB host controllers with different transmission power are disposed in the USB device. A USB host controller (for example, the first USB host controller) with lower transmission power is connected to the dedicated processor, and a USB host controller (for example, the second USB host controller) with higher transmission power is connected to the general-purpose processor. When data can be processed by the dedicated processor, the data exchange between the USB device and the dedicated processor is implemented by using the USB host controller with lower transmission power, to help further reduce power consumption.

Optionally, the USB device 210 includes a USB interface configured to connect to an external device; and

after the external device is removed from the USB interface, the switching control module 213 controls the first USB host controller 211, or the switching control module controls the second USB host controller.

In other words, after the external device is disconnected from the USB device 210, or before the external device is inserted into the USB device 210, in other words, in a default state of the data processing system, a relationship between the switching control module 213 and a USB host controller may be as follows: The switching control module 213 may control the first USB host controller 211, or the switching control module 213 may control the second USB host controller 212.

In the default state of the data processing system, if the switching control module 213 controls the first USB host controller 211, after the external device is inserted into the USB interface, the USB device 210 can directly exchange data with the dedicated controller 230; or if the switching control module 213 controls the second USB host controller 212, after the external device is inserted into the USB interface, the USB device 210 can directly exchange data with the general-purpose controller 220.

In addition, when the external device is inserted into the USB interface, regardless of which USB host controller is controlled by the switching control module 213, the switching control module 213 may flexibly switch the relationship between the switching control module 213 and the USB host controller based on an actual situation. For a specific implementation, refer to the following description.

Therefore, according to the data processing system provided in this embodiment of this application, in a default state (that is, after the external device is removed from the USB interface or before the external device is inserted into the USB interface), the data processing system may set a relationship between the switching control module and a USB host controller to reduce power consumption of the data processing system in different scenarios. If the switching control module controls a USB host controller (for example, the first USB host controller) connected to the dedicated processor, when data can be processed by the dedicated processor, the USB device can directly exchange data with the dedicated processor without performing a series of switching operations, so that power consumption is reduced. If the switching control module controls a USB host controller (for example, the second USB host controller) connected to the general-purpose processor, when data can be processed by the general-purpose processor, the USB device can directly exchange data with the general-purpose processor without performing a series of switching operations, so that power consumption is reduced.

Optionally, the USB device includes a USB interface configured to connect to an external device, and the general-purpose processor is configured to:

when the external device is inserted into the USB interface, obtain a device type of the external device; and

if the device type of the external device is an audio device, instruct the dedicated processor to exchange data with the USB device.

Specifically, after the external device is connected to the USB device 210 by using the USB interface, the general-purpose processor 220 may obtain the device type of the external device in two manners:

Manner 1:

The general-purpose processor 220 obtains the device type of the external device from the dedicated processor 230, to be specific, the dedicated processor 230 may send, to the general-purpose processor 220, first indication information used to indicate the device type of the external device, and the general-purpose processor 220 determines the device type of the external device based on the first indication information.

In the manner 1, in the default state (namely, a state in which the external device is not inserted into the USB interface, or a state in which the external device is removed from the USB interface) of the data processing system, the switching control module 213 controls the first USB host controller 211. After the external device is inserted into the USB interface, the external device can exchange data with the dedicated processor 230 by using the USB device 210. After obtaining the device type of the external device by using the USB device 210, the dedicated processor 230 sends the first indication information to the general-purpose processor 220, so that the general-purpose processor 220 obtains the device type of the external device.

Manner 2:

The general-purpose processor 220 obtains the device type of the external device from the USB device 210, to be specific, the USB device 210 sends, to the general-purpose processor 220, second indication information used to indicate the device type of the external device, and the general-purpose processor 220 determines the device type of the external device based on the second indication information.

In the manner 2, in the default state (namely, a state in which the external device is not inserted into the USB interface, or a state in which the external device is removed from the USB interface) of the data processing system, the switching control module 213 controls the second USB host controller 212. After the external device is inserted into the USB interface, the external device can exchange data with the general-purpose processor 220 by using the USB device 210, and the USB device 210 sends the second indication information to the general-purpose processor 220, so that the general-purpose processor 220 obtains the device type of the external device.

After the general-purpose processor 220 obtains the device type of the external device, a specific processor with which the USB device 210 exchanges data is determined. As an example instead of a limitation, two cases are used below for brief description.

Case 1:

If the device type of the external device is an audio device, it is determined that the USB device 210 can exchange data with the dedicated processor 230, to reduce a delay and power consumption. In this case, the dedicated processor 230 is instructed to exchange data with the USB device 210.

It should be understood that the data exchange described herein indicates that the dedicated processor 230 implements data transmission between the dedicated processor 230 and the USB device 210 by using the first driver.

In the case 1, if the general-purpose processor 220 obtains the device type of the external device based on the manner 1, that is, the general-purpose processor 220 obtains the device type of the external device from the dedicated processor 230, it indicates that the switching control module 213 is connected to the first USB host controller 211 by default, and the USB device 210 can exchange data with the dedicated processor 230. Therefore, the general-purpose processor 220 instructs, by sending indication information (denoted as third indication information for ease of differentiation and understanding), the dedicated processor 230 to exchange data with the USB device 210. For the dedicated processor, the dedicated processor 230 continues to exchange data with the USB device 210 based on the third indication information. If the general-purpose processor 220 obtains the device type of the external device based on the manner 2, that is, the general-purpose processor 220 obtains the device type of the external device from the USB device 210, it indicates that the switching control module 213 is connected to the second USB host controller 212 by default, and the USB device 210 can exchange data with the general-purpose processor 220. Therefore, the general-purpose processor 210 unloads the USB driver, and instructs, by sending indication information (denoted as fourth indication information for ease of differentiation and understanding), the dedicated processor 230 to exchange data with the USB device 210. For the dedicated processor 230, the dedicated processor 230 loads the first driver based on the fourth indication information, and drives, by using the first driver, the data exchange between the dedicated processor 230 and the USB device. In addition, the general-purpose processor 220 may also send, to the USB device 210, indication information used to instruct the switching control module 213 to switch between the USB host controllers, so that the switching control module 213 switches the second USB host controller 212 to the first USB host controller 211.

Case 2:

If the device type of the external device is a device (for example, a display device such as virtual reality (VR)) other than an audio device, it is determined that the USB device 210 can exchange data with the general-purpose processor 220, to improve a processing speed and processing quality. The general-purpose processor 220 may perform the following operations:

If the general-purpose processor 220 obtains the device type of the external device based on the manner 1, that is, the general-purpose processor 220 obtains the device type of the external device from the dedicated processor 230, it indicates that the switching control module 213 is connected to the first USB host controller 211 by default, and the USB device 210 can exchange data with the dedicated processor 230. Therefore, the general-purpose processor 220 may instruct the dedicated processor 230 to unload the first driver, and instruct the switching control module 213 to switch a connection state to the second USB host controller. If the general-purpose processor 220 obtains the device type of the external device based on the manner 2, that is, the general-purpose processor 220 obtains the device type of the external device from the USB device 210, it indicates that the switching control module 213 is connected to the second USB host controller 212 by default. Therefore, the general-purpose processor 220 can continue to exchange data with the USB device 210.

It should be understood that the foregoing cases in which the USB device and a specific processor are instructed, based on the device type of the external device, to exchange data with each other are merely used for illustration purpose, and shall not constitute a limitation on this embodiment of this application. For example, if the device type of the external device is a display device and/or an audio device, the general-purpose processor may instruct the dedicated processor to exchange data with the USB device. If the external device is an input device such as a mouse or a keyboard, the general-purpose processor may instruct the general-purpose processor to exchange data with the USB device.

Optionally, the dedicated processor 230 is a digital signal processing DSP processor.

Optionally, the USB device 210 includes a USB interface configured to connect to an external device, and the USB interface is a Type-C interface.

As an example instead of a limitation, the USB interface may alternatively be a Type-A interface, a Type-B interface, a sonic input/output (SIO) interface, or the like. This embodiment of this application is not limited thereto.

Therefore, according to the data processing system provided in this embodiment of this application, the dedicated processor is deployed with the first driver configured to drive the data exchange between the dedicated processor and the USB device, so that the USB device can exchange data with the dedicated processor. When data can be processed by the dedicated processor, the first driver in the dedicated processor may be directly used to drive the USB device, to implement the data exchange between the USB device and the dedicated processor. The general-purpose processor no longer needs to forward the data to the dedicated processor. Instead, the data can be directly transmitted between the USB device and the dedicated processor. A transmission delay is reduced. In addition, because the general-purpose processor no longer forwards the data to the dedicated processor, the general-purpose processor can enter a sleep state, and power consumption is also reduced.

In addition, two USB host controllers with different transmission power are disposed in the USB device. A USB host controller (for example, the first USB host controller) with lower transmission power is connected to the dedicated processor, and a USB host controller (for example, the second USB host controller) with higher transmission power is connected to the general-purpose processor. When data can be processed by the dedicated processor, the data exchange between the USB device and the dedicated processor is implemented by using the USB host controller with lower transmission power, to help further reduce power consumption.

In addition, in the default state (that is, after the external device is removed from the USB interface or before the external device is inserted into the USB interface), the data processing system may set a relationship between the switching control module and a USB host controller to reduce power consumption of the data processing system in different scenarios. If the switching control module controls a USB host controller (for example, the first USB host controller) connected to the dedicated processor, when data can be processed by the dedicated processor, the USB device can directly exchange data with the dedicated processor without performing a series of switching operations, so that power consumption is reduced. If the switching control module controls a USB host controller (for example, the second USB host controller) connected to the general-purpose processor, when data can be processed by the general-purpose processor, the USB device can directly exchange data with the general-purpose processor without performing a series of switching operations, so that power consumption is reduced.

An embodiment of this application further provides a data processing method. The method is applied to a data processing system including a Universal Serial Bus USB device, a general-purpose processor, and a dedicated processor. The USB device includes a USB interface configured to connect to an external device, the general-purpose processor is deployed with a USB driver, the dedicated processor is deployed with a first driver, and the first driver is configured to drive a data exchange between the USB device and the dedicated processor.

FIG. 5 is a schematic flowchart of a data processing method 400 according to an embodiment of this application. As shown in FIG. 5, the method includes the following steps.

S410. When the external device is inserted into the USB interface, the general-purpose processor obtains a device type of the external device.

S420. If the device type of the external device is an audio device, the general-purpose processor instructs the dedicated processor to exchange data with the USB device.

The data processing system in the method 400 may be either data processing system in FIG. 2 or FIG. 4. Therefore, the method 400 may be performed by a general-purpose processor in either data processing system in FIG. 2 or FIG. 4. Correspondingly, for specific implementation of each step in the method 400, refer to the description of the general-purpose processor in the foregoing embodiments. For more details, refer to the foregoing specific description about that the general-purpose processor instructs, based on the device type of the external device, a specific processor to exchange data with the USB device. For brevity, details are not described herein.

A person of ordinary skill in the art may be aware that, the units and algorithm steps in the examples described with reference to the embodiments disclosed in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

In the several embodiments provided in this application, it should be understood that the disclosed system and method may be implemented in other manners. For example, the described system embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, function units in the embodiments of this application may be integrated into one processing unit, or each of the units may exist alone physically, or two or more units are integrated into one unit.

When the functions are implemented in a form of a software function unit and sold or used as an independent product, the functions may be stored in a computer-readable storage medium. Based on such an understanding, the technical solutions of this application essentially, or the part contributing to the prior art, or some of the technical solutions may be implemented in a form of a software product.

The software product is stored in a storage medium, and includes several instructions for instructing a computer device (which may be a personal computer, a server, or a network device) to perform all or some of the steps of the methods described in the embodiments of this application. The foregoing storage medium includes: any medium that can store program code, such as a USB flash drive, a removable hard disk, a read-only memory (ROM), a random access memory RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A data processing system, wherein the data processing system comprises:
a Universal Serial Bus (USB) device;
a general-purpose processor, deployed with a USB driver; and
a dedicated processor, deployed with a first driver, wherein the first driver is configured to drive a data exchange between the USB device and the dedicated processor.

2. The data processing system according to claim 1, wherein the USB device comprises a USB interface connected to an external device, and the general-purpose processor is configured to:
when the external device is inserted into the USB interface, obtain a device type of the external device; and
when the device type of the external device is an audio device, instruct the dedicated processor to exchange data with the USB device.

3. The data processing system according to claim 1, wherein the USB device comprises a first USB host controller, a second USB host controller, and a switching controller, the first USB host controller is connected to the dedicated processor, the second USB host controller is connected to the general-purpose processor, the switching controller controls at least one of the first USB host controller or the second USB host controller, and transmission power consumption of the first USB host controller is lower than transmission power consumption of the second USB host controller.

4. The data processing system according to claim 3, wherein the USB device comprises a USB interface connected to an external device; and
after the external device is removed from the USB interface, the switching controller controls the first USB host controller, or the switching controller controls the second USB host controller.

5. The data processing system according to claim 1, wherein the dedicated processor is a digital signal processing (DSP) processor.

6. The data processing system according to claim 1, wherein the USB device comprises a USB interface connected to an external device, and the USB interface is a Type-C interface.

7. A terminal device, wherein the terminal device comprises a data processing system, and wherein the data processing system comprises:
a Universal Serial Bus (USB) device;
a general-purpose processor, deployed with a USB driver; and
a dedicated processor, deployed with a first driver, wherein the first driver is configured to drive a data exchange between the USB device and the dedicated processor.

8. The terminal device according to claim 7, wherein the USB device comprises a USB interface connected to an external device, and the general-purpose processor is configured to:
when the external device is inserted into the USB interface, obtain a device type of the external device; and
when the device type of the external device is an audio device, instruct the dedicated processor to exchange data with the USB device.

9. The terminal device according to claim 7, wherein the USB device comprises a first USB host controller, a second USB host controller, and a switching controller, the first USB host controller is connected to the dedicated processor, the second USB host controller is connected to the general-purpose processor, the switching controller controls at least one of the first USB host controller or the second USB host controller, and transmission power consumption of the first USB host controller is lower than transmission power consumption of the second USB host controller.

10. The terminal device according to claim 9, wherein the USB device comprises a USB interface connected to an external device; and
after the external device is removed from the USB interface, the switching controller controls the first USB host controller, or the switching controller controls the second USB host controller.

11. The terminal device according to claim 7, wherein the dedicated processor is a digital signal processing (DSP) processor.

12. The terminal device according to claim 7, wherein the USB device comprises a USB interface connected to an external device, and the USB interface is a Type-C interface.

13. A transmission processing method, applied to a data processing system comprising a Universal Serial Bus (USB) device, a general-purpose processor, and a dedicated processor, wherein the USB device comprises a USB interface connected to an external device, the general-purpose processor is deployed with a USB driver, the dedicated processor is deployed with a first driver, and the first driver is configured to drive a data exchange between the USB device and the dedicated processor; and the method comprises:
when the external device is inserted into the USB interface, obtaining, by the general-purpose processor, a device type of the external device; and
when the device type of the external device is an audio device, instructing, by the general-purpose processor, the dedicated processor to exchange data with the USB device.
